(19) United States
(12) Patent Application Publication
(10) Pub. No.: US 2016/0230699 A1
(43) Pub. Date: Aug. 11, 2016

(54) COMBINED CYCLE POWER GENERATION OPTIMIZATION SYSTEM

(71) Applicant: Neuco, Inc., Boston, MA (US)

(72) Inventors: Doug Bartlett, Duxbury, MA (US); Rob James, Lynn, MA (US); Fred Pickard, Norfolk, MA (US); John McDermott, Boston, MA (US); Peter Spinney, Cambridge, MA (US); Steve Piche, Austin, TX (US)

(73) Assignee: Neuco, Inc., Boston, MA (US)

(21) Appl. No.: 15/025,462

(22) PCT Filed: Sep. 5, 2014
(86) PCT No.: PCT/US14/54242

§ 371 Date: Mar. 28, 2016

Related U.S. Application Data
(60) Provisional application No. 61/874,652, filed on Sep. 6, 2013.

(51) Int. Cl. F02G 5/02; G05B 13/04

(52) U.S. Cl. CPC F02G 5/02; G05B 13/041

(57) ABSTRACT

Methods and apparatus for optimizing operation of a combined cycle power plant which combines the use of both gas and steam turbines in a single power generating plant. In one embodiment there is provided a closed-loop hybrid neural network-first principles optimizer for optimally allocating fuel across power generation plant blocks and sub [symbol] systems to minimize fuel costs while meeting capacity and ramp-rate commitments. Embodiments of the methods and apparatus include a steady state plant optimization model and a dynamic plant optimization model.

### RELATED APPLICATIONS

This application claims the benefit of U.S. Provisional Application No. 61/874,652, filed Sep. 6, 2013, which is hereby fully incorporated herein by reference.

### FIELD OF THE INVENTION

The present invention relates generally to methods and apparatus for operation of a combined cycle power plant (also referred to herein as “CCPP”) which combines the use of both gas and steam turbines in a single power generating plant, and more specifically to methods and apparatus for optimizing operation of a CCPP.

### BACKGROUND OF THE INVENTION

In recent years, CCPPs have become more common for generation of electric power due to the high efficiencies achieved with CCPPs, as compared with conventional power generating plants. A typical CCPP includes, but is not limited to: at least one gas turbine (also referred to as a “gas combustion turbine”), at least one steam turbine, and at least one heat recovery steam generator (HRSG), which is also referred to as a “heat recovery system” or a “boiler”. The gas turbine (GT) produces electric power from a fuel source, the HRSG generates steam by capturing heat from the exhaust of a GT, and the steam turbine (ST) produces electric power using steam produced by the HRSG. To boost performance of the HRSG, the HRSG may also include gas burners (also referred to as “duct burners”) to increase the amount of heat entering the HRSG.

In general, a gas turbine operates by pulling in air from the outside and pressurizing the air to provide compressed air to a combustion chamber. In the combustion chamber the compressed air is ignited by burning fuel (e.g., low sulphur fuel oil or natural gas). As the compressed air is heated it expands, thereby causing a turbine to rotate. The rotating turbine turns a generator that generates electric power. Heat exiting the gas turbine as exhaust gas (i.e., “waste heat”) is used as an energy input to the HRSG. As indicated above, the HRSG may also include duct burners to provide additional energy input. The output of the HRSG is high temperature steam that is supplied to a steam turbine that also generates electric power in connection with a generator.

The above-mentioned components of the CCPP may be arranged in a variety of configurations. For example, the components may be arranged in a single train where a gas turbine feeds a HRSG with a steam turbine, or two GT/HRSG pairs may share a single steam turbine. Furthermore, the components of a CCPP may be configured as elements of one or more “blocks.” Each block is comprised of at least one ST and at least one GT. The number of “blocks” in a CCPP is determined by the number of STs in the plant, while the number of “units” in the plant is determined by the number of GTs in the plant. Each GT and each ST produces electric power. A CCPP may also include one or more air pollution control (APC) devices for removal of pollutants from flue gas; at least one stack for release of flue gas; and at least one water cooling system for condensing high temperature steam. An example of one typical CCPP will be described in detail below.

CCPPs are currently the second leading source of electric power in the United States. A CCPP can provide higher efficiency and can often ramp up and down on load more rapidly than coal-fired power generating units. For this reason, CCCPs are often used to provide load balancing to the electric grid as load across the grid increases and decreases.

Allocation of load to individual power plants in the electric grid is determined automatically by regional power authorities (e.g., an independent system operator (ISO) or a regional transmission organization (RTO)). Typically, a power generating plant is connected to a system referred to as Automatic Generation Controller (AGC). The AGC determines the load required for a given plant. In cases where an AGC is not available, another system is used to determine the overall generation requirements for the plant.

Given the load requirements, determination of the load within a power generating plant may need to be done at the site of the power generating plant. For a CCPP, it is common for the AGC system to establish a plant-wide load for the entire CCPP, and the CCPP then makes an on-site allocation of the established plant-wide load among the various turbines or blocks of the CCPP. The most common method of allocation of the plant-wide load is based upon simple “rules of thumb” or lookup tables. For example, a first GT may take the lowest low range and ramp up production of electric power to a certain point after which a second GT may be turned on and ramp up to the next level of electric power production.

Although such “rules of thumb” or look up tables are easy to implement, they do not provide optimal performance of the CCPP. For example, if the first GT is more efficient than the second GT, then it would be more economical to start the first GT prior to starting the second GT. Similarly, if starting the burners on a first GT is more efficient that starting the burners on a second GT, then it would be more economical to start the burners on the first GT prior to starting the burners on the second GT.

The present invention overcomes drawbacks of the prior art, and provides methods and apparatus for optimizing operation of a combined cycle power plant.

### SUMMARY OF THE INVENTION

In accordance with the present invention, there is provided an optimization system for a combined cycle power plant having one or more gas turbines, one or more steam turbines, and one or more boilers associated with the one or more steam turbines, wherein a duct burner is associated with at least one of said boilers, said optimization system comprising: a load prediction model for determining a predicted maximum load for the plant; a plant optimization model including: (i) a plant power model for determining a predicted plant power produced by the plant, wherein said predicted plant power is determined by summing a total predicted gas turbine power produced by the one or more gas turbines and a total predicted steam turbine power produced by the one or more steam turbines, and (ii) a duct burner power model for determining a predicted duct burner power indicative of plant power due solely to one or more duct burners that are associated with the one or more boilers for producing steam for the one or more steam turbines; and an optimizer for determining optimal setpoint values for manipulated variables associated with operation of the plant, given (a) a goal associated with operation of the plant and (b) constraints associated with operation of the plant, wherein the optimizer uses said predicted maximum load for the plant, said predicted plant power produced by the plant and said predicted duct burner power to determine the setpoint values.

In accordance with another aspect of the present invention, there is provided a method for optimizing operation of a combined cycle power plant having one or more gas turbines, one or more steam turbines, and one or more boilers associated with the one or more steam turbines, wherein a duct burner is associated with at least one of said boilers, said method comprising the steps of: determining a predicted maximum load for the plant; using a plant optimization model to (i) determine a predicted plant power produced by the plant and (ii) determine a predicted duct burner power indicative of plant power due solely to one or more duct burners that are associated with the one or more boilers for producing steam for the one or more steam turbines; and using an optimizer to determine optimal setpoint values for manipulated variables associated with operation of the plant, given (a) a goal associated with operation of the plant and (b) constraints associated with operation of the plant, wherein the setpoint values are determined by the optimizer using said predicted maximum load for the plant, said predicted plant power produced by the plant and said predicted duct burner power.

An advantage of the present invention is the provision of an optimization system for optimizing operation of a power generating plant.

Another advantage of the present invention is the provision of an optimization system for optimizing operation of a power generating plant to achieve optimal allocation of load within the plant.

Another advantage of the present invention is the provision of an optimization system for optimizing operation of a power generating plant to achieve greater efficiency in the allocation of fuel within the plant.

Still another advantage of the present invention is the provision of an optimization system for optimizing operation of a power generating plant to achieve optimal performance of the plant.

Still another advantage of the present invention is the provision of an optimization system for optimizing operation of a power generating plant to achieve improved reliability of the plant.

A still further advantage of the present invention is the provision of an optimization system for optimizing operation of a power generating plant to achieve improved capacity of the plant.

Yet another advantage of the present invention is the provision of an optimization system for optimizing operation of a power generating plant to achieve reduced plant emissions.

These and other advantages will become apparent from the following description taken together with the accompanying drawings and the appended claims.

### BRIEF DESCRIPTION OF THE DRAWINGS

The invention may take physical form in certain parts and arrangement of parts, embodiments of which will be described in detail in the specification and illustrated in the accompanying drawings which form a part hereof, and wherein:

FIG. 1 is a block diagram of a combined cycle power plant (CCPP) that is an example of a power generating plant suitable for use in connection with the optimization system of the present invention;

FIG. 2 illustrates a block diagram of an optimization system according to an embodiment of the present invention;

FIG. 3 illustrates a block diagram of a load prediction model, according to an embodiment of the present invention;

FIG. 4 is a flow diagram illustrating the determination of a Predicted Max Load at time (t+1), according to an embodiment of the present invention;

FIG. 5 is a block diagram of a gas turbine power model, according to an embodiment of the present invention;

FIG. 6 is a block diagram of a steam turbine power model, according to an embodiment of the present invention;

FIG. 7 is a block diagram of a “block” power model, according to an embodiment of the present invention;

FIG. 8 is a simplified block diagram of the “block” power model shown in FIG. 7.

FIG. 9 is a block diagram of a plant power model, according to an embodiment of the present invention;

FIG. 10 is a simplified block diagram of the plant power model shown in FIG. 9;

FIG. 11 illustrates use of the plant power model of FIG. 10 to determine a Predicted Max Power With No Duct Burners at time (t);

FIG. 12 is a block diagram of a duct burner power model, according to an embodiment of the present invention, said duct burner power model shown as used to determine Predicted Plant Power Due Solely To Duct Burners at time (t);

FIG. 13 is a simplified block diagram of the duct burner power model shown in FIG. 12;

FIG. 14 illustrates a method for determining Predicted Plant Power Error at time (t).

FIG. 15 is a block diagram illustrating a steady state plant optimization model, according to an embodiment of the present invention;

FIG. 16 is a block diagram of a dynamic gas turbine power model, according to an embodiment of the present invention, wherein ambient conditions and trajectories of gas turbine fuel flows are used to determine the trajectory of gas turbine power;

FIG. 17 is a block diagram of a dynamic steam turbine power model, according to an embodiment of the present invention, wherein ambient conditions and trajectories of gas turbine power and duct burner fuel flows are used to determine the trajectory of steam turbine power; and

FIG. 18 is a block diagram of a dynamic plant optimization model, according to an embodiment of the present invention.

### DETAILED DESCRIPTION OF INVENTION

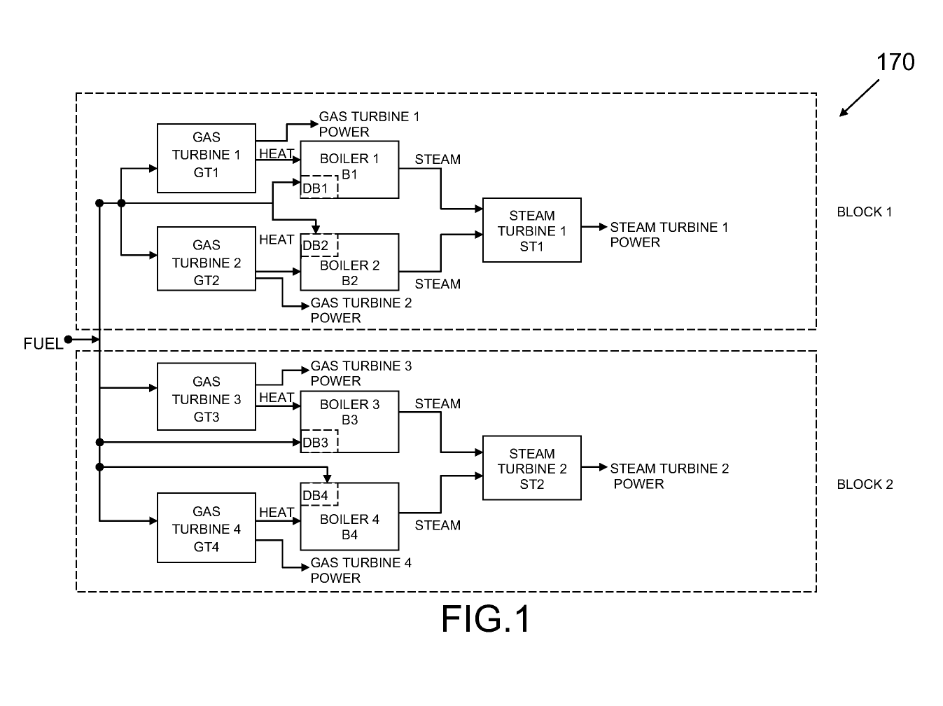

Referring now to the drawings wherein the showings are for the purposes of illustrating embodiments of the invention only and not for the purposes of limiting same, FIG. 1 shows a block diagram of a combined cycle power plant (CCPP) 170, which is also referred to herein as plant 170. Plant 170 is an example of a power generating plant that is suitable for use in connection with the optimization system of the present invention. The following description of the present invention illustrates an embodiment configured for use with plant 170. However, the present invention is suitable for use with a wide variety of CCPPs of alternative configurations, and therefore, it should be appreciated that the present invention may take alternative forms suitable for use with CCPPs having configurations different from plant 170. It should be understood that the illustration of plant 170 is not intended to limit the scope of the present invention.

In general, for a CCPP, fuel (typically natural gas) is input into a set of gas turbines and boilers. As indicated above, a boiler can also be referred to as Heat Recovery Steam Generator (HRSG). The gas turbines produce both electric power and heated flue gas that flows into a boiler. Duct burners in the boilers (or near the front of the boilers) can be used to add additional heat to the flue gas entering the boilers. The boilers produce steam which is used to power steam turbines that produce electric power.

In the illustrated plant 170, there are four gas turbines (identified as GT1, GT2, GT3 and GT4), four boilers (identified as B1, B2, B3 and B4) having associated duct burners (identified as DB1, DB2, DB3 and DB4), and two steam turbines (identified as ST1 and ST2). As can be seen in FIG. 1, each gas turbine GT1-GT4 is respectively followed by a boiler B1-B4. Boilers B1 and B2 produce steam for a common steam turbine ST1 and boilers B3 and B4 produce steam for a common steam turbine ST2. Illustrated plant 170 has two power generation blocks. A first power generation block (identified as BLOCK 1) is comprised of two gas turbines GT1, GT2; two boilers B1, B2 and a steam turbine ST1. A second power generation block (identified as BLOCK 2) is comprised of two gas turbines GT3, GT4; two boilers B3, B4 and a steam turbine ST2.

The power respectively produced by the gas turbines GT1-GT4 is identified as GT1 Power, GT2 Power, GT3 Power and GT4 Power. The power respectively produced by the steam turbines ST1, ST2 is identified as ST1 Power and ST2 Power. The total overall power produced by plant 170, known as plant load, is the summation of the power produced by the four gas turbines GT1-GT4 and the two steam generators ST1, ST2.

### Optimization System

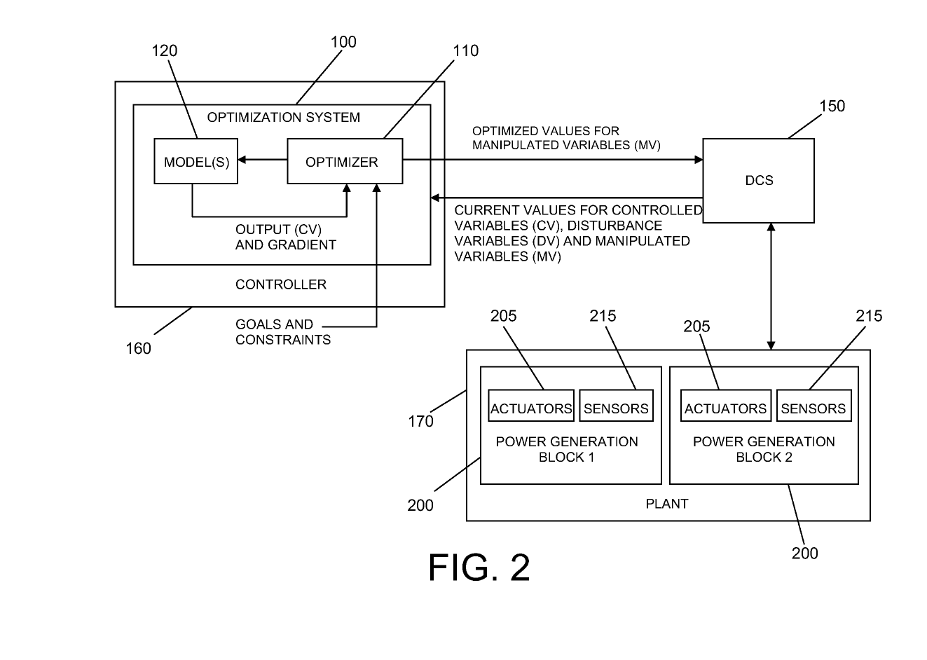

FIG. 2 illustrates a block diagram of an optimization system 100. In the illustrated embodiment, optimization system 100 is comprised of an optimizer 110 and model(s) 120. Optimizer 110 and model(s) 120 are both described in greater detail below. In accordance with an illustrated embodiment, optimization system 100 may form part of a supervisory controller 160 that communicates with a distributed control system (DCS) 150. DCS 150 is a computer-based control system that provides regulatory control of power generating plant 170. DCS 150 includes processors or programmable logic controllers (PLC). Supervisory controller 160 is a computer system that provides supervisory control data to DCS 150. It should be understood that in an alternative embodiment, model(s) 120 may reside on a different computer system than optimizer 110.

In a typical DCS, control elements are not only located in a central location, but are also distributed throughout a system with each component sub-system controlled by one or more controllers. The entire system of controllers is connected by networks for communication and monitoring. A DCS also includes input and output modules. The controllers receive data from input modules and sends data to output modules. The input modules receive data from input components (e.g., sensors 215) at plant 170, and the output modules transmit instructions to output components at the plant (e.g., actuators 205). The inputs and outputs can be either analog signals which are continuously changing or discrete signals which are two-state (either on or off). Buses connect the controllers and modules through multiplexer or demultiplexers. The buses also connect the controllers with a central controller and finally to an operator interface or control console (not shown). The operator interface provides means for an operator to communicate with DCS 150. DCS 150 may also communicate with a historian (not shown).

As described with respect to FIG. 1, illustrated plant 170 includes two power generation blocks (BLOCK 1, BLOCK 2). Each power generation block is comprised of gas and steam turbines, and a plurality of actuators 205 and sensors 215. Actuators 205 include devices for actuating components such as valves, dampers, inlet guide vanes). Sensors 215 include devices for sensing various system parameters (e.g., temperature, (barometric) pressure, relative humidity, fluid flow rates, and flue gas components).

Model(s) 120 will now be broadly described. In this respect, model(s) 120 are used to represent the relationship between (a) manipulated variables (MV) and disturbance variables (DV) and (b) controlled variables (CV). Manipulated variables (MVs) may be changed by the operator or optimization system 100 to affect the controlled variables (CVs). As used herein, disturbance variables refer to variables (associated with components of the power generating plant) that affect the controlled variables, but cannot be manipulated by the operator (e.g., ambient conditions at the power generating plant). Optimizer 110 determines an optimal set of setpoint values for the manipulated variables given (1) a desired goal associated with operation of the power generating plant (e.g., minimizing fuel consumption) and (2) constraints associated with operation of power generating plant (e.g., meeting required power demand).

At a predetermined frequency (e.g., every 10-60 seconds), optimization system 100 obtains the current values of manipulated variables, controlled variables and disturbance variables from DCS 150. An “optimization cycle” commences each time the current values for the manipulated variables, controlled variables and disturbance variables are read out from DCS 150.

As will be described in further detail below, optimization system 100 uses model(s) 120 to determine an optimal set of setpoint values for the manipulated variables based upon current conditions of plant 170. The optimal set of setpoint values are sent to DCS 150. An operator of plant 170 has the option of using the optimal set of setpoint values for the manipulated variables. In most cases, the operator allows the computed optimal set of setpoint values for the manipulated variables to be used as setpoint values for control loops. Optimization system 100 runs in a closed loop adjusting the setpoint values of the manipulated variables at a predetermined frequency (e.g., every 10-60 seconds) depending upon current operating conditions of power generation block 200. Optimization systems are described in U.S. Pat. No. 8,295,953 to Piche (“System for Optimizing Power Generating Unit”), issued Oct. 23, 2012, which is fully incorporated herein by reference.

It should be understood that the optimization system (including optimizer and model(s) described herein) may be implemented in various different ways well known to those skilled in the art. These implementations include the use of one or more programmed computer systems. Each computer system may include one or more processors, one or more controllers, data storage devices (e.g., memory, hard drive, etc.), input devices (e.g., keyboard, mouse, touch screen and the like), and output devices (e.g., display devices such as monitors and printers). The computer system may communicate with components of the power plant via any suitable data communications medium including, but not limited to, a wired network, a wireless RF network, a fiber optic network, telephone lines, the Internet, or combinations of these mediums.

### Neural Network Based Dynamic Model

To properly capture the relationship between the manipulated/disturbance variables and the controlled variables, model(s) 120 may have the following characteristics:
Nonlinearity: A nonlinear model is capable of representing a curve rather than a straight line relationship between manipulated/disturbance and controlled variables. For example, a nonlinear, curved relationship is often observed between fuel flow and power.
Multiple Input Multiple Output (MIMO): The model must be capable of capturing the relationships between multiple inputs (manipulated/disturbance variables) and multiple outputs (controlled variables).
Dynamic: Changes in the inputs do not instantaneously affect the outputs. Rather there is a time delay and follow by a dynamic response to the changes. It may take 15-30 minutes for changes in the inputs to fully propagate through the system. Since optimization systems execute at a predetermined frequency (e.g., an optimization cycle commencing every 10-60 seconds), the model must represent the effects of these changes over time and take them into account.
Adaptive: The model must be updated at the beginning of each optimization cycle (e.g., every 10-60 seconds) to reflect the current operating conditions of a boiler.
Derived from Empirical Data: Since each boiler is unique, the model must be derived from empirical data obtained from the power generating plant.

Given the foregoing requirements, a neural network based approach is presently the preferred means for implementing models in accordance with the present invention. Neural networks are developed based upon empirical data using advanced regression algorithms. See, for example, C. Bishop, Pattern Recognition and Machine Learning, Springer, New York, N.Y., 2006, fully incorporated herein by reference. Neural networks are capable of capturing the nonlinearity commonly exhibited by boilers. Neural networks can also be used to represent systems with multiple inputs and outputs. In addition, neural networks can be updated using either feedback biasing or on-line adaptive learning. Finally, neural networks can be developed to take disturbance in account, as described in U.S. Pat. No. 7,123,971 to Piche (“Non-Linear Model With Disturbance Rejection”), issued Oct. 17, 2006.

Dynamic models can also be implemented in a neural network based structure. A variety of different types of model architectures have been used for implementation of dynamic neural networks, as described in S. Piche, “Steepest Descent Algorithms for Neural Network Controllers and Filters,” IEEE Trans. Neural Networks, vol. 5, no. 2, pp. 198-212, 1994 and A. Barto, “Connectionist Learning for Control,” Neural Networks for Control, edited by W. Miller, R. Sutton and P. Werbos, MIT Press, Cambridge, Mass., pp. 5-58, Jan. 3, 1990, both of which are fully incorporated herein by reference. Many of the neural network model architectures require a large amount of data to successfully train the dynamic neural network. A novel neural network structure, which may be trained using a relatively small amount of data, was developed in the late 1990's. Complete details on this dynamic neural network based structure are provided in S. Piche, B. Sayyar-Rodsari, D. Johnson and M. Gerules, “Nonlinear Model Predictive Control Using Neural Networks,” IEEE Control Systems Magazine, vol. 20, no. 2, pp. 53-62, June 2000, which is fully incorporated herein by reference.

Given a model of a power generating plant, it is possible to determine the effects of changes in the manipulated variables on the controlled variables. Furthermore, since the model is dynamic, it is possible to determine the effects of changes in the manipulated variables over a future time horizon (i.e., multiple changes rather than a single change).

### First Principles Based Model

Empirical modeling techniques are described above for developing relationships between input and outputs of systems to be modeled. Empirical models work well in data rich and knowledge poor situations, i.e., the relationship between input and output is not well understood, but there are large amounts of data available to “learn” the relationship.

In situations where the relationship between the input and output is well known, that relationship can be used directly in the model. For example, equations representing performance of a feedwater heater, a type of heat exchanging commonly used in power generating plants, are well known and published in textbooks on the subject. These equations can be written directly into a model of a feedwater heater. The parameters of such models would be based upon the design parameters of the equipment which is commonly available. Thus, given the design equations, a very precise model of a piece of equipment can be developed based upon “first principle” knowledge of the system. Such models are referred to as “first principles models.”

In power generating plants, well known thermodynamic equations can be used for developing models of many of the components of both coal-fired and combined cycle power plants. See K. C. Cotton, Evaluating and Improving Steam Turbine Performance, Second Edition, Cotton Fact, Rexford, N.Y., 1998. This may include models of the gas turbine, steam turbine, HRSG, condenser, feedwater heaters and other major components. Since these models are based upon thermodynamic equations that are based upon well known equations, they are also referred to as rigorous thermodynamic models.

These models may be interconnected to form a larger model of an entire unit, entire power generating block or an entire power generating plant. Because there is feedback among the components, it may be necessary to use an optimizer to solve for the overall model.

### Optimizer

An optimizer is used to minimize a “cost function” subject to a set of constraints. The cost function is a mathematical representation of a desired goal or goals. For instance, to minimize fuel flow, the cost function includes a term that decreases as the level of fuel flow decreases. One common method for minimizing a cost function is known as “gradient descent optimization.” Gradient descent is an optimization algorithm that approaches a local minimum of a function by taking steps proportional to the negative of the gradient (or the approximate gradient) of the function at the current point.

Since the model is dynamic, the effects of changes must be taken into account over a future time horizon. Therefore, the cost function includes terms over a future horizon, typically 30 minutes for CCPP optimization. Since the model is used to predict over a time horizon, this approach is commonly referred to as model predictive control (MPC). Model Predictive Control is described in detail in S. Piche, B. Sayyar-Rodsari, D. Johnson and M. Gerules, “Nonlinear Model Predictive Control Using Neural Networks,” IEEE Control Systems Magazine, vol. 20, no. 2, pp. 53-62, 2000, which is fully incorporated herein by reference. Also see E. Camacho and C. Alba, Model Predictive Control, Springer, New York, N.Y., 2007.

Constraints may be placed upon both the inputs (MVs) and outputs (CVs) over the future time horizon. Typically, constraints that are consistent with limits associated with the DCS are placed upon the manipulated variables. Constraints on the outputs (CVs) are determined by the problem that is being solved.

A nonlinear model can be used to determine the relationship between the inputs and outputs of a plant. Accordingly, a nonlinear programming optimizer is used to solve the optimization problem in accordance with an embodiment of the present invention. However, it should be understood that a number of different optimization techniques may be used depending on the form of the model and the costs and constraints. For example, it is contemplated that the present invention may be implemented by using, individually or in combination, a variety of different types of optimization approaches. These optimization approaches include, but not limited to, linear programming, quadratic programming, mixed integer non-linear programming (NLP), stochastic programming, global non-linear programming, genetic algorithms, and particle/swarm techniques. See R. Baldick, Applied Optimization: Formulation and Algorithms for Engineering Systems, Cambridge University Press, Cambridge, UK, 2009.

Given the cost function and constraints, a non-linear program (NLP) optimizer typically solves problems with 20 manipulated variables and 10 controlled variables in less than one second. This is sufficiently fast for most applications since the optimization cycle is typically in the range of 10-60 seconds. Additional details on the formulation of the cost function and constraints are provided in the above-mentioned reference S. Piche, B. Sayyar-Rodsari, D. Johnson and M. Gerules, “Nonlinear model predictive control using neural networks,” IEEE Control Systems Magazine, vol. 20, no. 2, pp. 53-62, 2000, which is fully incorporated herein by reference.

The optimizer computes the full trajectory of manipulated variable moves over the future time horizon, typically 30 minutes. For an optimization system that executes every 60 seconds, 30 values are computed over a 30 minute future time horizon for each manipulated variable. Since the model or goals/constraints may change before the next optimization cycle, only the first value in the time horizon for each manipulated variable is output by the optimization system to the DCS as a setpoint value for each respective manipulated variable.

At the next optimization cycle, typically 60 seconds later, the model is updated based upon the current conditions of the plant. The cost function and constraints are also updated if they have changed. Typically, the cost function and constraints are not changed. The optimizer is used to recompute the set of values for the manipulated variables over the time horizon and the first value in the time horizon, for each manipulated variable, is output to the DCS as the setpoint value for each respective manipulated variable. The optimization system repeats this process for each optimization cycle (e.g., every 60 seconds), thus, constantly maintaining optimal performance as the boiler is affected by changes in such items as load, ambient conditions, boiler conditions, and fuel characteristics.

### Rules-Based System

An alternative approach to solving the optimization problem described above is to use a rules-based approach which is reliant upon using an “expert system” to determine the optimal setpoints for the MVs to achieve the desired goals of the system. It is contemplated that the optimization system of the present invention may include the use of a rules-based system.

### Load Prediction

The load demand to a power generating plant provides a real-time desired mega-watt (MW) generation demand for the plant. However, it does not contain any information about the potential future demand for the plant.

It is advantageous to know the future load profile in order to better allocate resources in the power generating plant. Given that a future load profile is not available, it is necessary to estimate such a profile. With respect to one embodiment of the present invention, one future load profile that is of interest is the maximum possible load for the plant at some time in the future. In accordance with this embodiment of the present invention, it is desired to know the maximum value of the load for the plant at a predetermined time in the future, e.g., 30 minutes in the future. Furthermore, it is an objective in this embodiment to guarantee that the prediction of maximum load in 30 minutes is greater than the actual load 30 minutes later at least 97.5% of the time. The prediction of the maximum load at 30 minutes in the future is used as part of the optimization process to determine the fuel flows to the gas turbines and duct burners, as will be described in detail below.

Empirical data is available for load at power generating plants for the past several of years. This data can be used to train a neural network to predict the future load profile. Typically, the following inputs can be used in the prediction: calendar information, grid frequency, time of day, ambient conditions, as well as current and past loads.

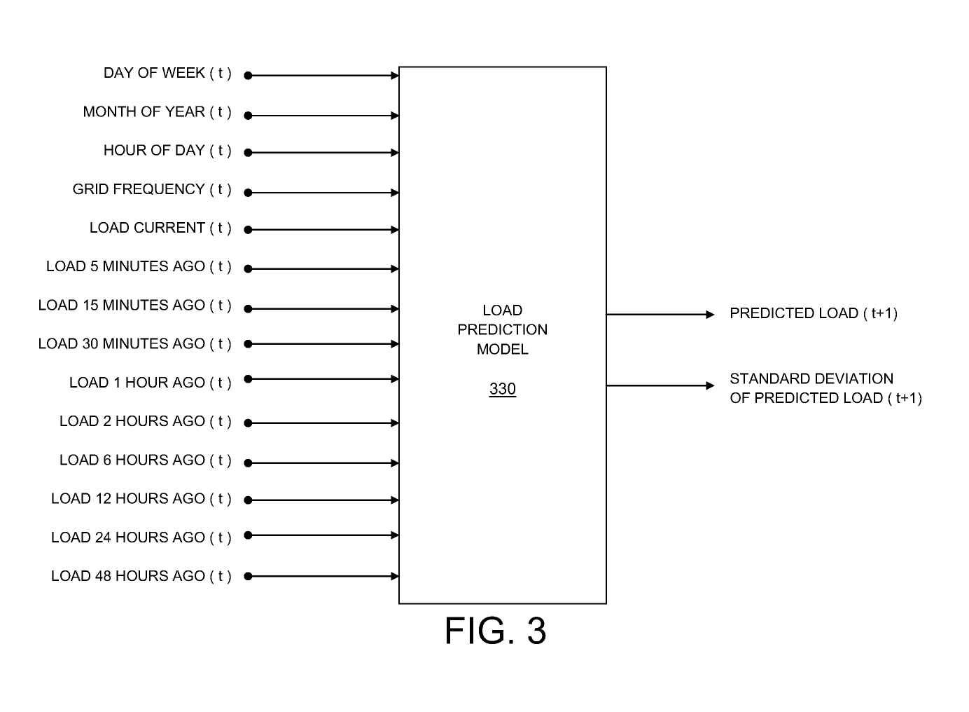

FIG. 3 illustrates a load prediction model 330 according to an embodiment of the present invention. Using the model inputs at current time (t), model 330 is used to predict the load of plant 170 in the future at time (t+1), which is shown as an output identified as Predicted Load (t+1). In the illustrated embodiment, the time in the future (t+1) is 30 minutes from the current time (t). It should be appreciated that the selection of 30 minutes for t+1 is solely for the purpose of illustrating an embodiment of the present invention, and is not intended to limit same. Model 330 also has an output that is the standard deviation of the predicted load at time (t+1), which is identified as Standard Deviation of Predicted Load (t+1).

Data for the inputs to model 330 is collected from current time (t) and used to predict the load at time (t+1) and the standard deviation of the predicted load at time (t+1). In the illustrated embodiment of load prediction model 330, the model inputs include: Day Of Week, which is represented by the integers 1-7; Month Of The Year, represented by an integer from 1-12, Hour Of Day, represented by an integer from 1-24; current frequency of the grid (Grid Frequency) in units of Hertz; current load in mega-watts (MW) of the plant (Load Current); and delayed versions of the load from the previous 5 minutes (Load 5 Minutes Ago), 15 minutes (Load 15 Minutes Ago), 30 minutes (Load 30 Minutes Ago), 1 hour (Load 1 Hour Ago), 2 hours (Load 2 Hours Ago), 6 hours (Load 6 Hours Ago), 12 hours (Load 12 Hours Ago), 24 hours (Load 24 Hours Ago), and 48 hours (Load 48 Hours Ago). The above-mentioned Day of Week, Month of Year and Hour of Day information is collectively referred to as “calendar data.”

It should be appreciated that the above-identified inputs for model 330 are for the purpose of illustrating an embodiment of the present invention, and not for limiting same. It is contemplated that alternative inputs may be used in load prediction model 330 in connection with the present invention.

In accordance with one embodiment of the present invention, load prediction model 330 is a neural network model that is trained using historical data from the plant. Model 330 is trained using data collected over the past year at 30 minute sampling periods of the inputs and output of interest (plant load). Data associated with plant downtime when the plant was not producing a load is not included in the training data. Neural network training algorithms, such as backpropagation (C. Bishop, Pattern Recognition and Machine Learning, Springer, New York, N.Y., 2006), are used to train model 330 to predict the load at time (t+1) (i.e., 30 minutes in advance) using data at time (t).

Once model 330 has been trained, the Standard Deviation of Predicted Load can be determined using the standard deviation of the error between the predicted and actual data over the training data. Alternatively, Bayesian techniques as describe in C. Bishop, Pattern Recognition and Machine Learning, Springer, New York, N.Y., 2006, can be used to determine both Predicted Load and Standard Deviation Of Predicted Load based upon the values of the inputs to model 330. In this approach, the standard deviation varies as a function of the inputs to model 330.

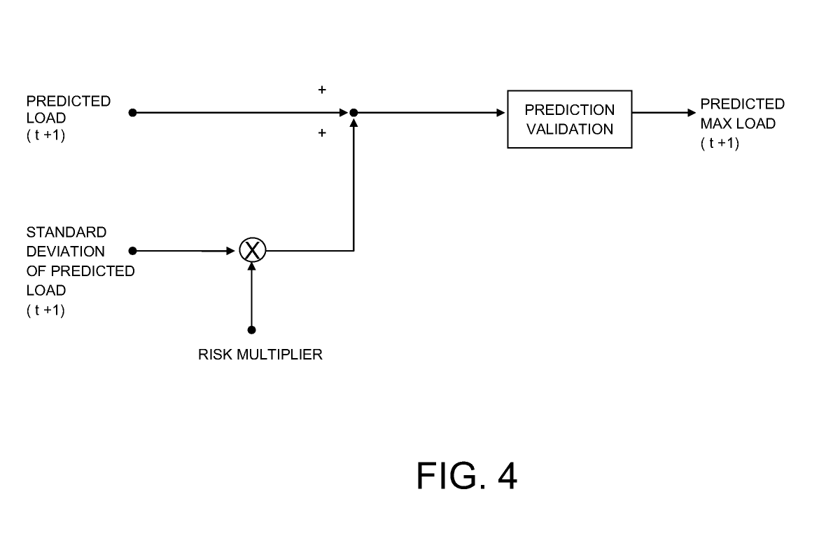

Predicted Load (t+1) and Standard Deviation Of Predicted Load (t+1) are used to predict the maximum load in the future at time (t+1) (i.e., 30 minutes in the future). Referring now to FIG. 4, there is shown a flow diagram of the process for determining Predicted Maximum Load (t+1). Standard Deviation Of Predicted Load (t+1) of FIG. 3 is multiplied by a Risk Multiplier, and then added to Predicted Load (t+1) of FIG. 3. The Risk Multiplier is used to bound the probability of the load at time (t+1) being lower than the Predicted Maximum Load (t+1). In one embodiment of the present invention, a Risk Multiplier of 2 is used. A multiplier of 2 bounds the probability of being lower than Predicted Maximum Load (t+1) to 0.975. As shown in FIG. 4, a Prediction Validation block is also included. This block is included to allow a rules-based system to verify the accuracy of the prediction. In the illustrated embodiment, the Prediction Validation block in used to guarantee that the predicted change in load is greater than user specified minimum values (e.g., 10 MW). Predicted Maximum Load (t+1) is used in the optimization system described below. The models used in the optimization system will now be described.

### Plant Models

Load allocation within a power generating plant can be achieved using optimization system 100 shown in FIG. 2. In an embodiment of the present invention, a model of the entire power generating plant is required. The plant model may be developed using a first principles model, a neural model, a dynamic model or any other appropriate method. In addition, the plant model may be derived by combining different types of model techniques, such as the use of a first principles model for one component and a neural network model for another component.

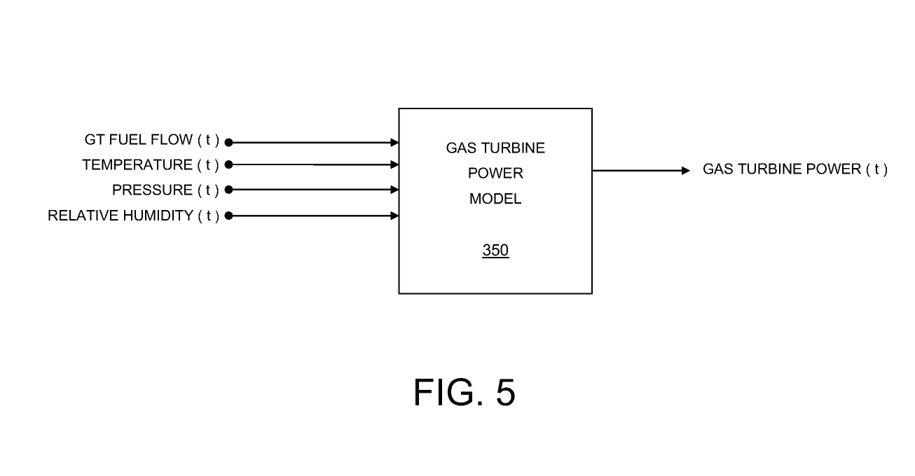

In one embodiment of the present invention, the plant model used for optimization is derived by developing component models for the gas turbines GT1-GT4, as well component models for the combination of the steam turbines ST1, ST2 and associated boilers B1-B4. These component models are then connected together to form models of each power generation block (i.e., BLOCK1 and BLOCK2), and then the block models are connected together to provide a model of the power generating plant. Building of the plant model will now be described in detail with reference to FIG. 5.

FIG. 5 shows a gas turbine power model 350 for the power produced by a gas turbine given the inputs GT Fuel Flow and ambient conditions (e.g., Temperature, Pressure, and Relative Humidity). In the illustrated embodiment, model 350 is used to predict the power produced by the gas turbine at current time (t), based upon the current conditions at time (t). In one embodiment of the present invention, it is assumed that model 350 is used to predict gas turbine operation at a steady state condition. Thus, it is assumed that the model inputs have been held approximately constant over the past few minutes such that any dynamics of the system do not affect the output of model 350. Dynamic models of a gas turbine and a steam turbine/boiler will be discussed in detail below.

It will be appreciated that various approaches described above can be used to create gas turbine power model 350. In one embodiment of the present invention, gas turbine power model 350 is created by training a neural network with historical data. In this case, 3 months of data of the inputs and outputs is collected at 15 minute samples. Samples that are not at steady state (i.e., inputs held approximately constant over the past 15 minutes) and samples where the gas turbine is off are removed from the data set. The remaining data is used to train the neural network model and provides an accurate prediction of the gas turbine power at time (t), given the GT fuel flow and ambient conditions.

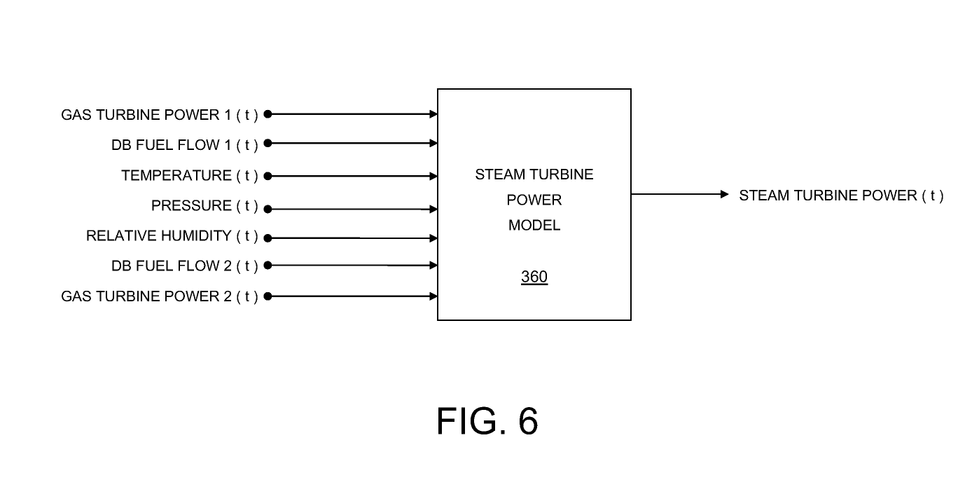

Referring now to FIG. 6, there is shown a steam turbine power model 360 for the power produced by a steam turbine. For plant 170 shown in FIG. 1, the steam turbine power for each steam turbine ST1, ST2 is based upon the steam from two boilers. The two boilers are powered by the heat from respective gas turbines and additional heat from respective duct burners. In this case, to predict the steam turbine power, it is possible (and equivalent) to use the gas turbine power as a proxy for the heat input received from the gas turbine, since the heat input is often not directly measured. Thus, in FIG. 6, Gas Turbine Power from the gas turbines is used as an input to steam turbine power model 360. Other inputs to model 360 include: Duct Burner (DB) Fuel Flow and ambient conditions (Temperature, Pressure, and Relative Humidity).

Similar to gas turbine power model 350 described above, historical data over the past 3 months is used to train a neural network model of the steam turbine power. Once again, steady state, non-zero load, 15 minute samples of the inputs and outputs are used to train steam turbine power model 360. Once gas turbine power model 350 and steam turbine power model 360 have been trained, they may be combined to provide a block power model and a plant power model, as will be described in detail below.

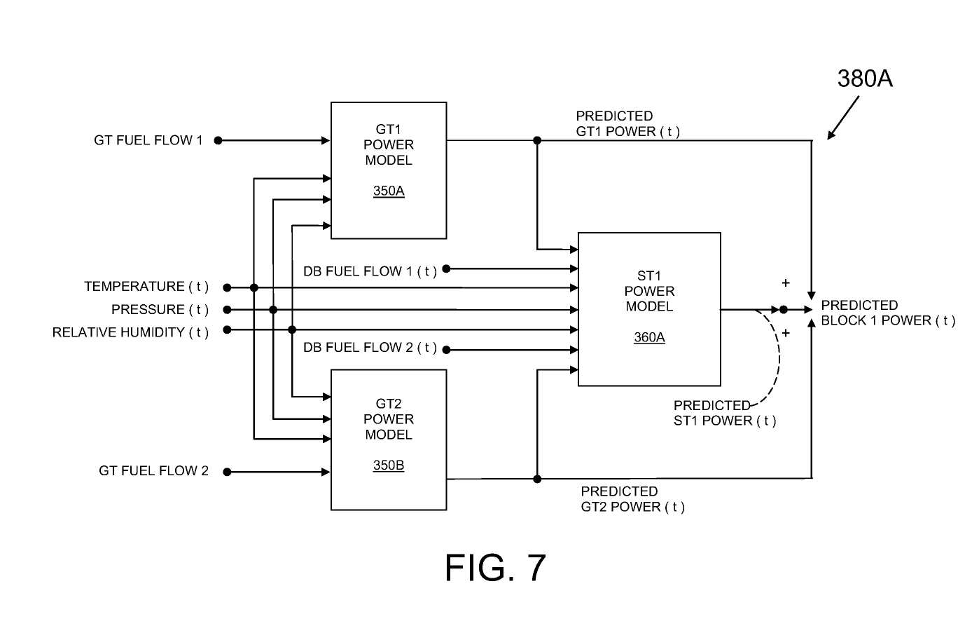

Referring now to FIG. 7, two gas turbine power models 350 (as presented in FIG. 5) and one steam turbine power model 360 (as presented in FIG. 6) are combined to provide a block power model. In FIG. 7, the two gas turbine power models are identified as GT1 power model 350A and GT2 power model 350B, and the steam turbine power model is identified as ST1 power model 360A. The combined models 350A, 350B and 360A are identified as BLOCK 1 power model 380A.

The inputs to each gas turbine power model 350A, 350B are GT Fuel Flow and ambient conditions (i.e., Temperature, Pressure and Relative Humidity). The inputs to ST1 power model 360A are the predicted gas turbine power from both gas turbines (as determined by models 350A and 350B), the duct burner fuel flows associated with boilers B1 and B2, and the ambient conditions. It is important to note that the prediction of the gas turbine power is used as an input to the steam turbine model instead of the actual gas turbine power. The effects of changes in the GT fuel flow on steam turbine power can be predicted by chaining together GT power models 350A, 350B and steam power model 360A, as shown in FIG. 7. The predicted power from the gas turbine models 350A, 350B and steam turbine model 360A are added together to produce the predicted power for BLOCK 1. Again, model 380A is a steady state model, thus, the inputs to model 380A at time (t) can be used to predict the BLOCK 1 output power at time (t).

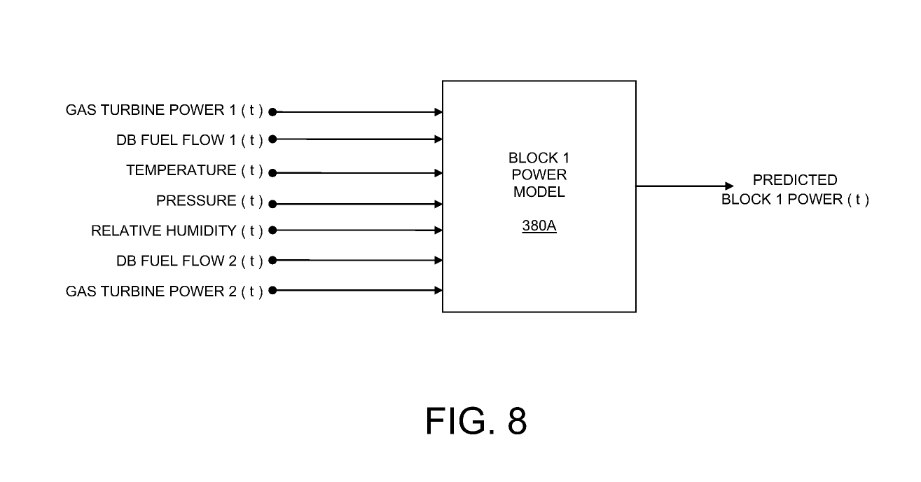

FIG. 8 illustrates a simplified version of FIG. 7 which only shows the inputs and output of BLOCK 1 power model 380A, and not the internal models and connections therebetween. It can be observed that model 380A of FIG. 8 is comprised of the components and connections shown in FIG. 7.

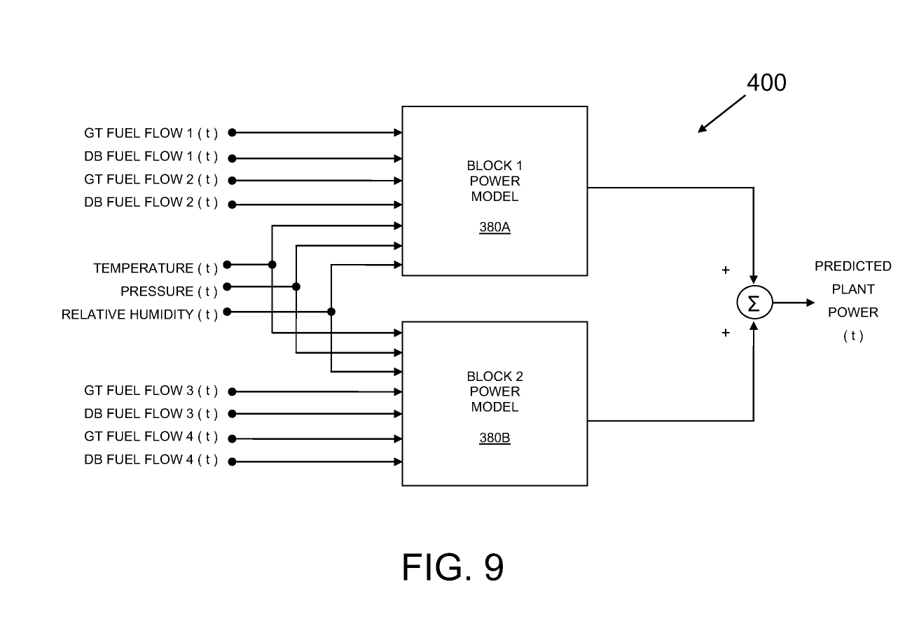

It should be appreciated that for plant 170 shown in FIG. 1, a BLOCK 2 power model 380B (FIG. 9) is developed in the same manner as BLOCK 1 power model 380A described above. The predicted power for BLOCK 2 is produced by adding together predicted power from gas turbine models for gas turbine 3 (GT3) and gas turbine 4 (GT4) and a steam turbine model for steam turbine 2 (ST2). Like BLOCK 1 power model 380A, BLOCK 2 power model 380B is a steady state model, and thus, the inputs to the BLOCK 2 power model at time (t) can be used to predict the BLOCK 2 output power at time (t).

Referring now to FIG. 9, plant power can be modeled as plant power model 400 by using the two block power models for BLOCK 1 and BLOCK 2 (shown as BLOCK 1 power model 380A and BLOCK 2 power model 380B). In this case, the four fuel flows to the gas turbines (GT1-GT4) and the four fuel flows to the duct burners (DB1-DB4) are inputs to block power models 380A, 380B along with the ambient conditions. The output of block power models 380A and 380B are summed together to provide the predicted plant power at time (t).

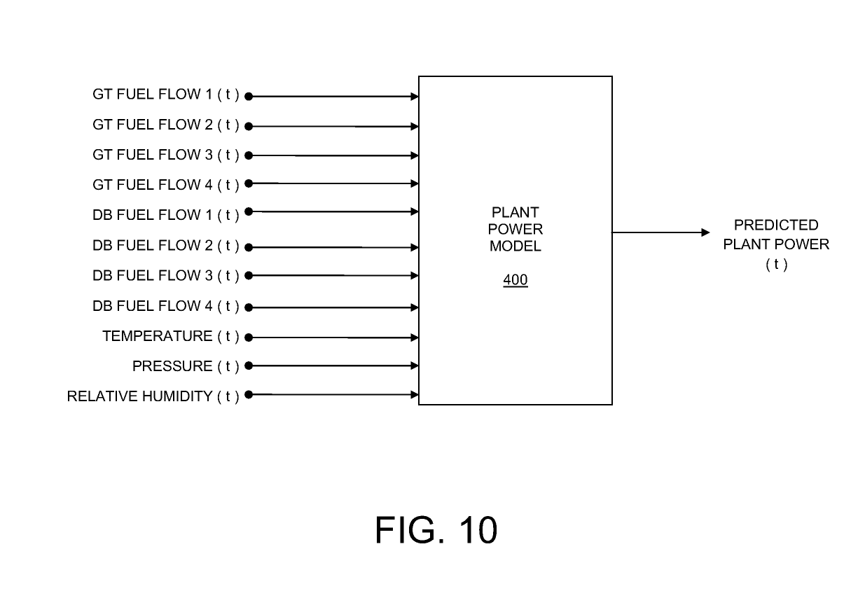

Again for simplification, plant power model 400 of FIG. 9 can be redrawn as FIG. 10 which only shows the inputs and outputs of plant power model 400 shown in FIG. 9, and not the internal models and connections therebetween. Plant power model 400 of FIG. 10 represents a full model for predicting the plant power in optimization system 100. Model 400 is comprised of four gas turbine power models and two steam turbine models. In the illustrated embodiment, each of the gas and steam turbine models is implemented by a neural network and trained based upon historical data.

Optimization system 100 described in detail below not only uses the power plant model 400 of FIG. 10, it also uses two other models: (1) a predicted maximum power of the plant with no duct burners in service and (2) a predicted plant power due solely to duct burners. These additional models can be derived using plant power model 400 of FIG. 10, as will now be described.

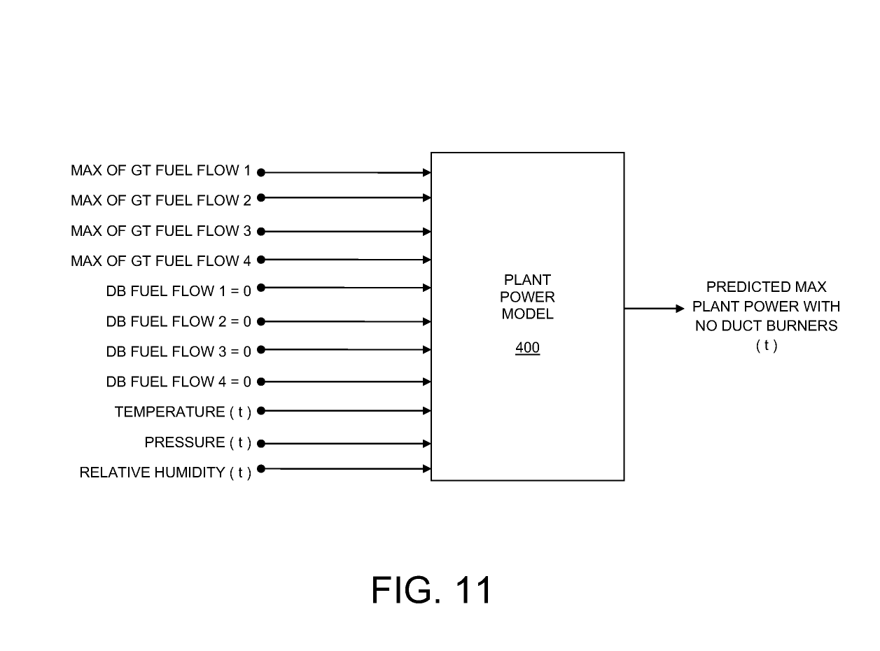

FIG. 11 shows a method for determining Predicted Maximum Power With No Duct Burners by use of plant power model 400. In this case, to determine the Predicted Maximum Power With No Duct Burners, the maximum GT fuel flow is input to model 400 for each of the gas turbines (GT1-GT4) and no duct burner fuel flow is input to model 400 for each of the duct burners (DB1-DB4). Accordingly, the GT fuel flow for GT1-GT4 is set to a maximum value and the DB fuel flow for DB1-DB4 is set to zero. Thus, using plant power model 400 of FIG. 10, a prediction of the maximum plant power with no duct burners in service can be determined, as shown in FIG. 11.

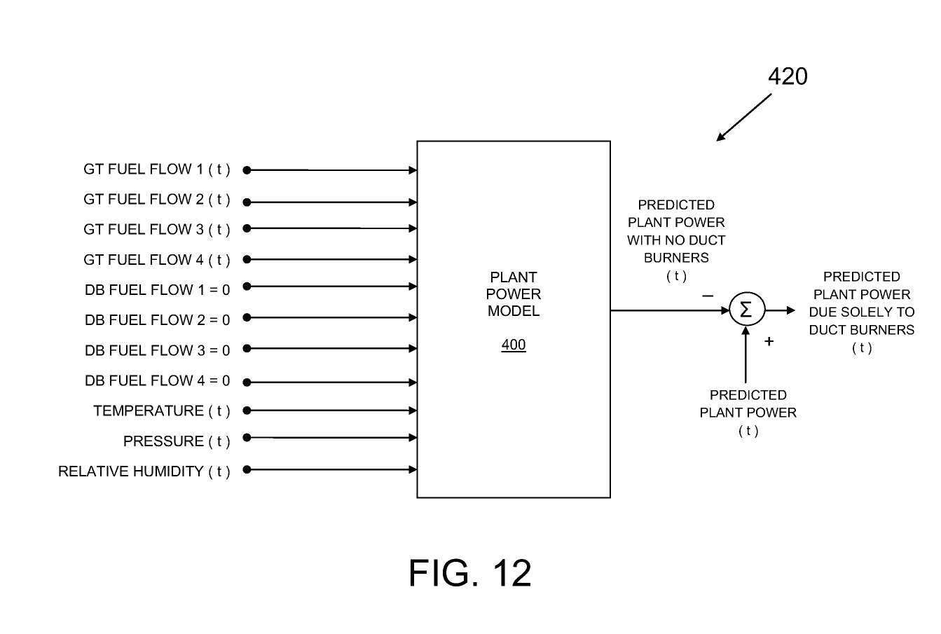

Referring now to FIG. 12, there is shown a duct burner power model 420 used to determine the Predicted Plant Power Due Solely To Duct Burners. Model 420 uses the output of plant power model 400 shown in FIG. 10 to determine the current predicted plant power, identified as Predicted Plant Power (t). As shown in FIG. 12, model 420 also uses plant power model 400 with the input duct burner fuel flows set to zero in order to predict plant power with no duct burners (identified as Predicted Plant Power With No Duct Burners (t)). By taking the difference between Predicted Plant Power (t) and Predicted Plant Power With No Duct Burners (t), the Predicted Plant Power Due Solely To Duct Burners at time (t) can be determined, as illustrated by FIG. 12.

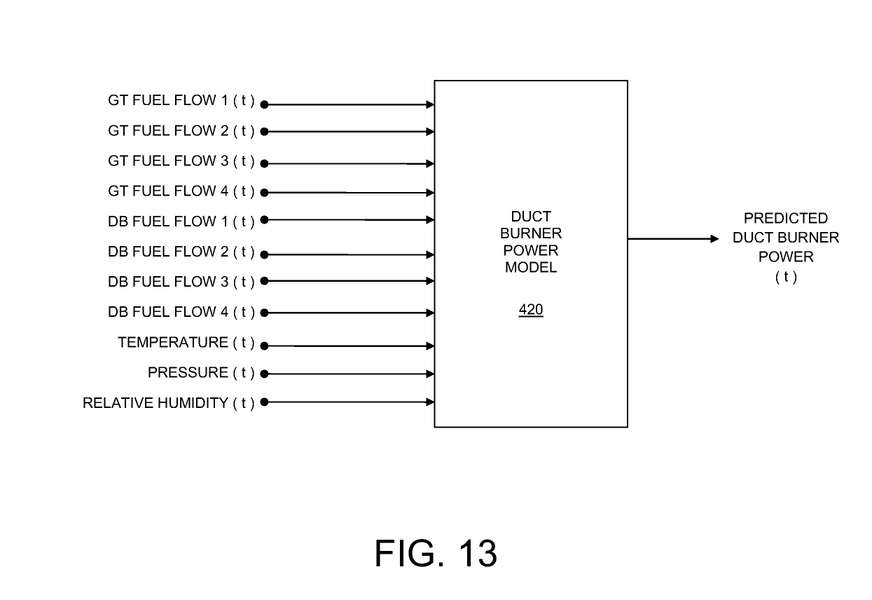

Again for simplicity, plant power models 400 shown in FIGS. 10 and 12 can be combined to form duct burner power model 420 shown in FIG. 13. Again, inputs and outputs to model 420 are shown, but individual models and connections therebetween are omitted. Duct burner power model 420 is a function of gas turbine fuel flows (GT Fuel Flow), duct burner fuel flows (DB Fuel Flow), and ambient conditions (i.e., Temperature, Pressure and Relative Humidity). It should be appreciated that the zero inputs for DB Fuel Flow (FIG. 10) are constant and moved internal to the duct burner power model 420 shown in FIG. 13.

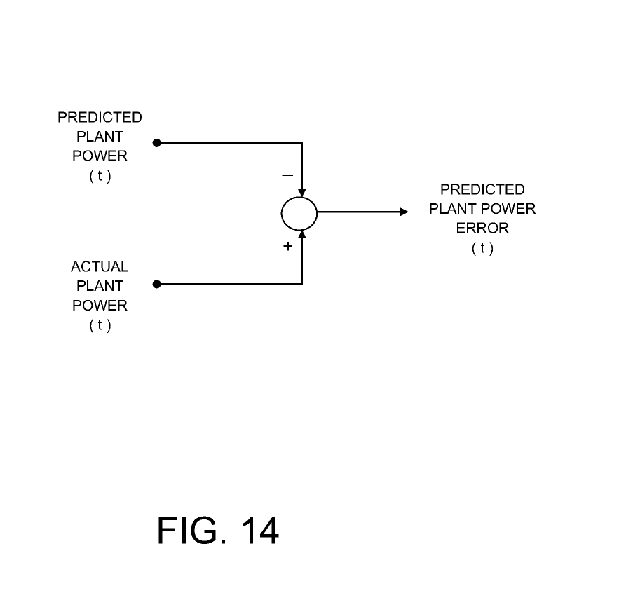

FIG. 14 shows the determination of predicted plant power error at time (t) by subtracting the predicting plant power at time (t) (as determined in FIG. 10) from the current actual plant power at time (t). The value for Predicted Plant Power Error (t) is used as feedback bias to actual conditions in a steady state plant optimization model 430, which will now be described in detail.

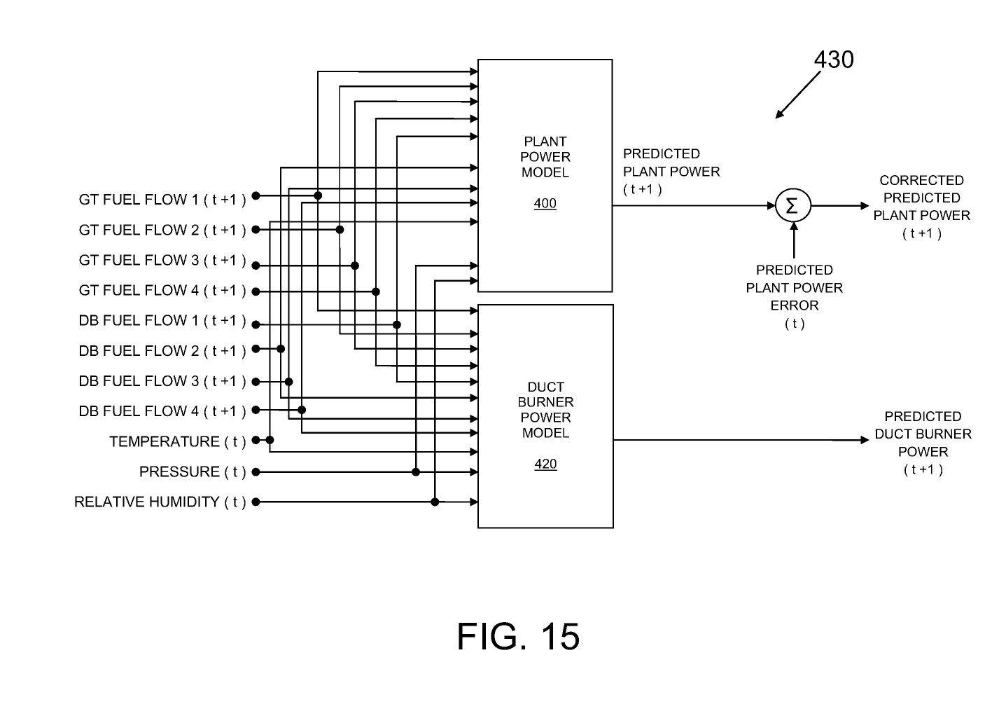

FIG. 15 shows steady state plant optimization model 430 comprised of plant power model 400 and duct burner power model 420, which are described in detail above. Optimizer 110 of optimization system 100 determines the fuel flow to the gas turbines GT1-GT4 and duct burners DB1-DB4 of boilers B1-B4 at time (t+1), such that a corrected predicted plant power at time (t+1) and predicted duct burner power at (t+1) minimize a cost function and set of constraints. Thus, models 400 and 420 shown in FIG. 15 use as inputs GT Fuel Flows and DB Fuel Flows at time (t+1) and respectively provide outputs of predicted plant power and predicted duct burner power at time (t+1). In one embodiment of the present invention, time (t+1) is 30 minutes from current time (t). Since the ambient conditions are not known in the future, the current value of the ambient conditions (i.e., ambient conditions at time (t)) are used as inputs to models 400 and 420. In addition, the current value of the Predicted Plant Power Error (t), as determined according to FIG. 14, is used to bias the Predicted Plant Power (t+1) to current conditions, since the value for Predicted Plant Power Error (t) is fixed in the optimization. It should be noted that the Predicted Plant Power Error (t) mitigates problems associated with modeling error.

Optimizer 110 of optimization system 100 can be used to manipulate the fuel flows in the future (i.e., at time t+1) in order to produce changes to the predicted plant power and predicted duct burner power in the future (i.e., at time t+1). Once optimization system 100 determines a solution, setpoints can be sent to plant 170 for the fuel flows, and the plant power and duct burner power should move approximately to the values predicted by model 430.

### Optimization

Given steady state plant optimization model 430 shown in FIG. 15, an optimization system may be used to determine manipulated variables (MVs) based upon the goals and constraints of the system. A variety of different optimization techniques may be used to solve the optimization problem including, but not limited to: nonlinear programming, steepest descent, genetic algorithms, Monte Carlo simulation, rules-based, linear programming, and expert systems.

The “goal” of the optimization system according to one embodiment of the present invention is to minimize the fuel usage while maintaining the required demand for power from the plant. It should be noted that the power plant receives a demand signal from a regional system provider and is required to meet this demand or otherwise pay a penalty. In addition, the gas turbines are used for fast ramping of the plant, while the duct burners are used to provide a minimum amount of power that is greater than or equal to the predicted maximum load at a predetermined time in the future (e.g., 30 minutes) minus predicted maximum plant power with no duct burners in use (if this value is greater than 0). By using the duct burners to provide the power associated with the difference between the predicted maximum load at the predetermined time in the future (e.g., 30 minutes) and the maximum plant power with no duct burners in use (again, assuming this is greater than zero), the power plant has the ability to deliver power to the electric grid at a fast ramp rate allowed by gas turbines (but not by duct burners). Since electric power producers get paid a premium for being able to quickly ramp their power generating plant, it is more profitable to be able to deliver power at a fast ramp rate even if it means using the more inefficient duct burners to provide that power. The goals and constraints of the optimizer of the optimization system will now be described in detail.

According to one embodiment of the present invention, the goal of the optimizer is to minimize the following cost function, J, given as:

Min(J(GT Fuel Flow,DB Fuel Flow)) (1)

where

J=Σᵢ₌₁⁴GT Fuel Flowᵢ(t+1)+Σᵢ₌₁⁴DB Fuel Flowᵢ(t+1) (2)

subject to the constraints:

Corrected Predicted Plant Power(t+1)=Demand(t) (3)

Predicted Duct Burner Power(t+1)≧Max(0,Predicted Max Load(t+1)−Predicted Max Power with no Duct Burners(t)) (4)

In addition, each of the fuel flows must be maintained within the allowable range of operation between typically 0% and 100% flow. In equations 1 and 2, the cost of fuel flow to the duct burners and gas turbines is minimized subject to the constraints in equations 3 and 4. In equation 3, the corrected predicted plant power must equal demand (i.e., the demand for power) where the Corrected Predicted Plant Power (t+1) is formally defined in FIG. 15 and the Demand (t) is provided by a demand command signal to the plant by the regional grid regulator. It should be noted that the Correct Predicted Plant Power (t+1) is a function of the variables being manipulated by the optimizer to solve this problem, i.e., Correct Predicted Plant Power (t+1) is a function of GT Fuel Flow i (t+1) and DB Fuel Flow i (t+1). The constraint in equation 4 is used to maintain gas turbine headroom such that the GT will be able to ramp quickly to pick up demand if needed. The Predicted Duct Burner Power (t+1) is defined in FIG. 15 and is also a function of GT Fuel Flow i (t+1) and DB Fuel Flow i (t+1). On the right hand side of equation 4, the Max function is used to guarantee that constraint never goes below zero if the value of Predicted Max Load (t+1)−Predicted Max Plant Power With No Duct Burners (t) goes below zero. The value of Predicted Max Load (t+1)−Predicted Max Plant Power With No Duct Burners (t) is independent of the manipulated variables (the fuel flows) and thus may be determined prior to the optimization run. It is determined using Predicted Max Load (t+1) shown in FIG. 4 and Predicted Max Plant Power With No Duct Burners (t) shown in FIG. 11.

The optimizer is used to minimize the fuel flows, maintain the load of the plant, and keep the duct burner power above the difference between the predicted maximum load at time t+1 and the predicted maximum plant power with no duct burners at time t, if that value is greater than 0. After the optimization run, the setpoints of the fuel flows to the gas turbines and duct burners are output to the plant. To keep the plant up-to-date with changing conditions such as demand, the optimization system may need to run an optimization cycle at a faster frequency than once every 30 minutes. Accordingly, the optimizer described above may be run more frequently or a model predictive control technique which uses dynamic models may be used to solve the optimization problem, as will now be described.

### Model Predictive Control

In an alternative embodiment of the present invention, a dynamic component is added to the plant model shown in FIG. 15. In this embodiment, the total load at current time (t) is predicted, and also the load at intervals in the future, specifically, every 1 minute over the next 30 minutes, is predicted. A model predictive control approach is subsequently used to solve for the trajectory of fuel flows over the next 30 minutes.

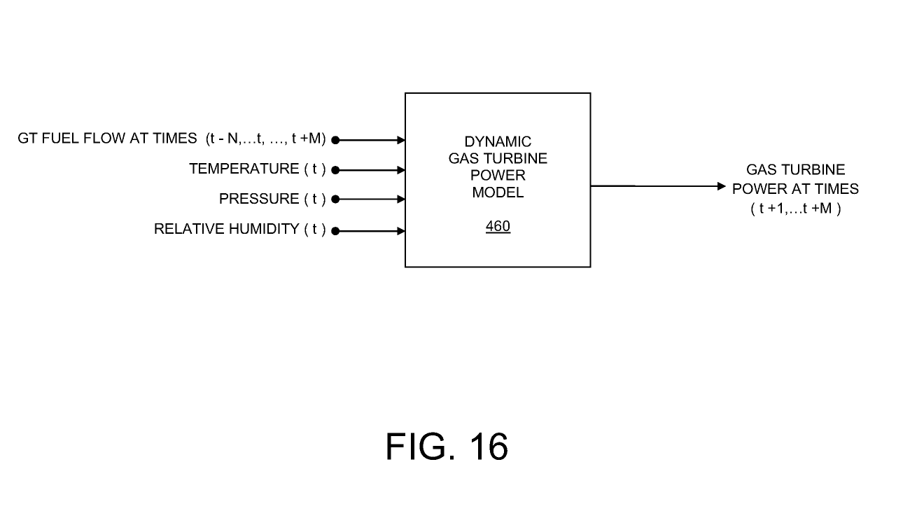

Referring now to FIG. 16, there is shown a dynamic gas turbine power model 460 where the input for GT fuel flow includes not only the value at current time, t, but also at future times, t+1, . . . , t+M. Optionally, model 460 includes a set of previous values of the fuel flow from time t−N, . . . , t−1. In one embodiment of the present invention, the time samples are at 1 minute intervals and the dynamic model uses 30 samples in the future. The output of model 460 is a prediction of the power produced by the gas turbine from current time, t, to time, t+M, (again, where M=30 in the one embodiment of the present invention). The current values of the ambient conditions are also used as inputs to model 460. It should be noted that if dynamic model 460 maintains a current state, it may not be necessary to input the GT Gas Flow at times prior to current times, since the state will effectively maintain the effects of these previous inputs. In an embodiment of the present invention where model 460 is used with internal state, only the current and future values of the fuel flow are needed to compute the dynamic response trajectory of the predicted gas turbine power.

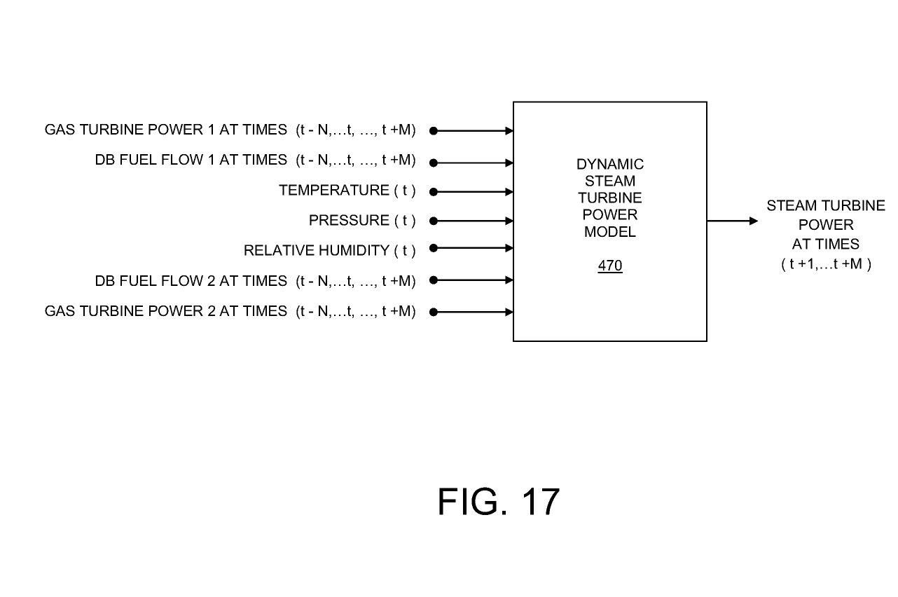

With reference to FIG. 17, there is shown a dynamic steam turbine power model 470 where the trajectories of the DB fuel flows and GT power are used to determine the trajectory of steam turbine power. In addition, the ambient conditions at the current time are used as inputs to model 470.

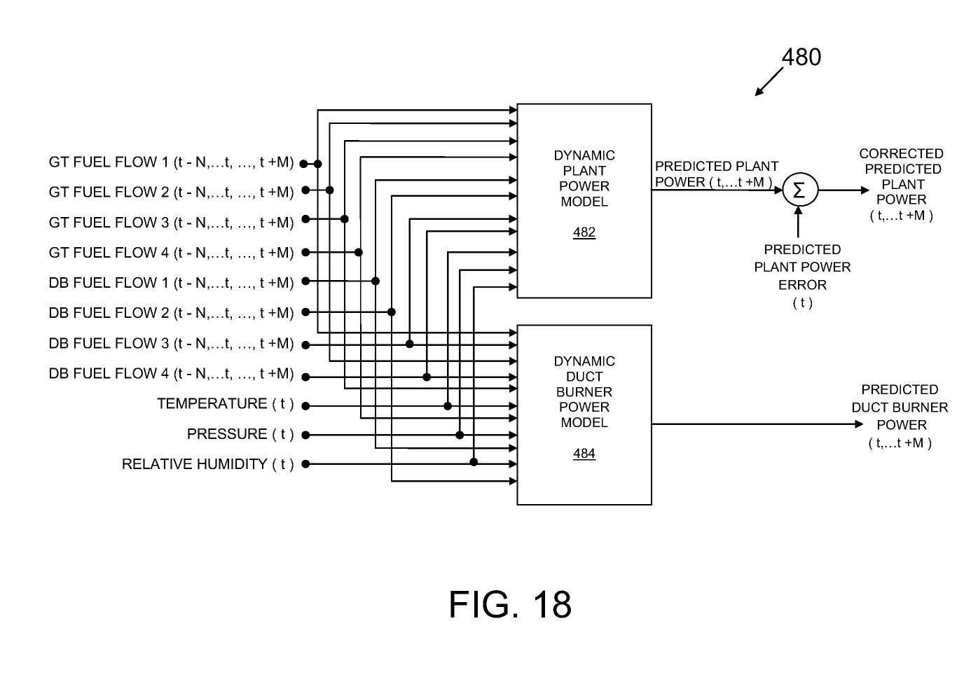

As shown in FIGS. 7-15, a steady state plant optimization model 430 is constructed using gas turbine power model 350 of FIG. 5 and steam turbine power model of FIG. 6. Similarly, a dynamic plant optimization model 480, shown in FIG. 18, can be constructed using the dynamic models 460 and 470 of FIGS. 16 and 17. The resulting dynamic plant optimization model 480 is similar to FIG. 15 except that the output of model 480 is a trajectory of Corrected Predicted Plant Power and a trajectory of Predicted Duct Burner Power. The GT and DB fuel flow inputs are also a trajectory of values from times t-N to t+M. In one embodiment of the present invention, the dynamic models 482 and 484 contain state, thus the GT and DB fuel flow trajectories from times t to t+M are used. It should be noted that the Predicted Plant Power Error (t) is added to every element of the trajectory of the Corrected Predicted Plant Power.

The goal of the dynamic optimization, also referred to as model predictive control, is to minimize fuel flow over the future trajectory from time t+1 to t+M, while meeting the demand and maintaining the duct burner power to be greater than the predicted maximum load at time t+M (e.g., in 30 minutes) minus the predicted maximum plant power with no duct burners over the future trajectory from time t+1 to t+M. Since the system is dynamic, it is not possible to guarantee that the duct burner power will be greater than the predicted maximum load at time t+M minus the predicted max plant power with no duct burners over the entire trajectory. In this respect, it may take some time for this constraint to be achieved. To accommodate the dynamic response, in the dynamic optimization, the hard constraint used in the steady state version (equation 4) is replaced by a soft constraint which is included in the cost function.

The goal of the dynamic optimizer is to minimize the following cost function, J, given as:

Min(J(GT Fuel Flow,DB Fuel Flow)) (5)

where

J=Σₘ₌₁^{M}Σᵢ₌₁⁴GT Fuel Flowᵢ(t+m)+Σₘ₌₁^{M}Σᵢ₌₁⁴DB Fuel Flowᵢ(t+m)+Σₘ₌₁^{M}G(Predicted Duct Burner Power(t+m)−(Max(0,Predicted Max Load(t+M)−Predicted Max Power with no Duct Burners(t))) (6)

where G(x)=0 if x>=0 and G(x)=x² if x<0, subject to the constraints:

for all m in {1, . . . ,M},Corrected Predicted Plant Power(t+m)=Demand(t)) (7)

In addition, each of the GT and DB fuel flows over the trajectory from t+1 to t+M must be maintained within the allowable range of operation between typically 0% and 100% flow. In equation 5 and 6, the cost of fuel flow to the duct burners and gas turbines is minimized along with a penalty term associated with the Predicted Duct Burner Power over the trajectory from t+1 to t+M being less than the Predicted Max Load at time t+M (in 30 minutes) minus the Predicted Max Plant Power with no Duct Burners at current time. In equation 7, the corrected predicted plant power over the future trajectory from t+1 to t+M must equal demand. The Corrected Predicted Plant Power (t+1, . . . , t+M) is formally defined in FIG. 18 and the Demand(t) is provided as a demand command signal to the plant by the regional grid regulator. It should be noted that the Corrected Predicted Plant Power (t+1, . . . , t+M) is a function of the variables being manipulated by the optimizer to solve this problem, i.e., Corrected Predicted Plant Power (t+1, . . . , t+M) is a function of GT Fuel Flow i (t+1, . . . , t+M) and DB Fuel Flow i (t+1, . . . , t+M). The third term of the cost function in equation 6 is used to maintain gas turbine headroom such that the GT will be able to ramp up quickly to pick up demand if needed. The Predicted Duct Burner Power (t+1, . . . , t+M) is defined in FIG. 18 and is also a function of GT Fuel Flow i (t+1, . . . , t+M) and DB Fuel Flow i (t+1, . . . , t+M). On the right hand side of equation 6, the Max function is used. The Max function is used to guarantee that the penalty never goes below zero if the value of Predicted Max Load (t+M)−Predicted Max Power with No Duct Burners (t) goes below zero. The value of Predicted Max Load (t+M)−Predicted Max Power with No Duct Burners (t) is independent of the manipulated variables (the fuel flows) and thus may be computed prior to the optimization run. It is computed using FIG. 4 for Predicted Max Load (t+M) and FIG. 11 for the Predicted Max Plant Power with No Duct Burners (t). Thus, like the steady state optimization described above, the dynamic optimizer is used to minimize the fuel flows, maintain the load of the plant, and keep the duct burner power above the difference between the predicted max load at time t+1 and the predicted max plant power with no duct burners if that value is greater than 0.

One of the advantages of a dynamic optimizer (model predictive controller) is that it can be executed at a high frequency. In one embodiment of the present invention, the optimizer is executed every 1 minute and the results of the optimization at time (t+1) are output to the DCS. It is important to note that only the first value in the trajectory of fuel flows is actually used for control of the plant. After 1 minute, the dynamic optimization is rerun using the most current values from the plant, and the optimal trajectories are recomputed. Since the Demand, as well as the actual load, is changing minute-by-minute, this will result in a slightly different computation of the trajectories for the fuel flows at each optimization cycle. Again, only the first value of the fuel flow trajectories is output to the DCS. This cycle continues every minute with the optimizer constantly determining new values for the fuel flows.

The above description shows a variety of different techniques that may be used to solve the load allocation problem within a power generating plant (i.e., a combined cycle power plant).

The present invention described above uses adaptive on-line learning neural networks in combination with rigorous thermodynamic modeling to employ the most efficient possible firing regime (i.e., loading across combustion turbines, HRSGs, duct burners, and steam turbines) while meeting the maximum capacity and load-following. Neural network modeling and optimization can be used to both capture knowledge in plant data to find and apply in real-time optimal firing regimes across the entire range of total plant output and relevant ambient conditions, such as temperature, humidity, and barometric pressure. Neural network modeling can also be employed to provide a short-term forecast of mega-watt (MW) demand for the plant's output, to ensure the any given firing regime is capable of meeting ancillary services commitments for ramp rate and Automatic Generation Control (AGC). Real-time rigorous thermodynamic modeling is used to inform the empirical modeling and optimization of key subsystem interactions (such as that between combustion turbine, HRSG, and steam turbine efficiencies) and dynamics, using condition-based rules that exploit this thermodynamic knowledge. Such knowledge also helps inform overall operations strategies and tuning of the loops in the underlying distributed control system (DCS).

Other modifications and alterations will occur to others upon their reading and understanding of the specification. For instance, at coal-fired power generating plants, it is not unusual for the AGC system to determine the load for each coal-fired unit of the power generating plant. Although it is common for coal-fired units to be dispatched externally, in some cases, the coal-fired units may individual be allocated within the site of the power generating plant. In such cases, it is contemplated that the present invention may also find utility in connection with a coal-fired power generating plant. It is intended that all such modifications and alterations be included insofar as they come within the scope of the invention or the equivalents thereof.

Having described the invention, the following is claimed:

1. An optimization system for a combined cycle power plant having one or more gas turbines, one or more steam turbines, and one or more boilers associated with the one or more steam turbines, wherein a duct burner is associated with at least one of said boilers, said optimization system comprising:
a load prediction model for determining a predicted maximum load for the plant;
a plant optimization model including:
a plant power model for determining a predicted plant power produced by the plant, wherein said predicted plant power is determined by summing a total predicted gas turbine power produced by the one or more gas turbines and a total predicted steam turbine power produced by the one or more steam turbines, and
a duct burner power model for determining a predicted duct burner power indicative of plant power due solely to one or more duct burners that are associated with the one or more boilers for producing steam for the one or more steam turbines; and
an optimizer for determining optimal setpoint values for manipulated variables associated with operation of the plant, given (a) a goal associated with operation of the plant and (b) constraints associated with operation of the plant, wherein the optimizer uses said predicted maximum load for the plant, said predicted plant power produced by the plant and said predicted duct burner power to determine the setpoint values.

2. An optimization system according to claim 1, wherein said plant optimization model is a steady state model.

3. An optimization system according to claim 1, wherein said plant optimization model is a dynamic model.

4. An optimization system according to claim 1, wherein said plant power model includes:
one or more gas turbine power models for respectively providing a predicted gas turbine power produced by the one or more gas turbines of the plant; and
one or more steam turbine power models for respectively providing a predicted steam turbine power produced by the one or more steam turbines of the plant.

5. An optimization system according to claim 1, wherein inputs to the plant optimization model include:
fuel flows for each of said one or more gas turbines;
fuel flows for the one or more duct burners associated with said one or more boilers for producing steam for said one or more steam turbines; and
ambient conditions at the plant.

6. An optimization system according to claim 5, wherein said ambient conditions include: temperature, pressure and relative humidity.

7. An optimization system according to claim 1, wherein said plant power model further provides a predicted maximum plant power with none of said duct burners operating, wherein inputs to the plant power model to provide said predicted maximum plant power with none of said duct burners operating include:
maximum fuel flows for each of said one or more gas turbines;
fuel flows of zero for said duct burners; and
ambient conditions.

8. An optimization system according to claim 1, wherein said load prediction model provides a predicted load for the plant and a standard deviation of the predicted load for the plant.

9. An optimization system according to claim 1, wherein inputs to the load prediction model include:
calendar data indicative of day of week, month of year and hour of day at the current time (t);
frequency of an electric grid associated with the plant at the current time (t);
load of the plant at the current time (t); and
load of the plant at one or more times prior to the current time (t).

10. An optimization system according to claim 1, wherein said plant power model includes:
one or more block power models for providing a predicted block power produced by each power generation block of the plant.

11. An optimization system according to claim 1, wherein said goal is represented by a cost function.

12. A method for optimizing operation of a combined cycle power plant having one or more gas turbines, one or more steam turbines, and one or more boilers associated with the one or more steam turbines, wherein a duct burner is associated with at least one of said boilers, said method comprising:
determining a predicted maximum load for the plant;
using a plant optimization model to (i) determine a predicted plant power produced by the plant and (ii) determine a predicted duct burner power indicative of plant power due solely to one or more duct burners that are associated with the one or more boilers for producing steam for the one or more steam turbines; and
using an optimizer to determine optimal setpoint values for manipulated variables associated with operation of the plant, given (a) a goal associated with operation of the plant and (b) constraints associated with operation of the plant, wherein the setpoint values are determined by the optimizer using said predicted maximum load for the plant, said predicted plant power produced by the plant and said predicted duct burner power.

13. A method according to claim 12, wherein said predicted plant power is determined by summing a total predicted gas turbine power produced by the one or more gas turbines and a total predicted steam turbine power produced by one or more steam turbines.

14. A method according to claim 12, wherein said plant optimization model is a steady state model.

15. A method according to claim 12, wherein said plant optimization model is a dynamic model.

16. A method according to claim 12, wherein said predicted plant power produced by the plant is determined by using one or more gas turbine power models for respectively providing a predicted gas turbine power produced by the one or more gas turbines of the plant; and using one or more steam turbine power models for respectively providing a predicted steam turbine power produced by the one or more steam turbines of the plant.

17. A method according to claim 12, wherein inputs to the plant optimization model include:
fuel flows for each of said one or more gas turbines;
fuel flows for the one or more duct burners associated with said one or more boilers for producing steam for said one or more steam turbines; and
ambient conditions at the plant.

18. A method according to claim 17, wherein said ambient conditions include:
temperature, pressure and relative humidity.

19. A method according to claim 12, wherein said method further comprises:
using a plant power model to determine a predicted maximum plant power with none of said duct burners operating, wherein inputs to the plant power model to determine said predicted maximum plant power with none of said duct burners operating include:
maximum fuel flows for each of said one or more gas turbines;
fuel flows of zero for said duct burners; and
ambient conditions.

20. A method according to claim 12, wherein said predicted maximum load for the plant is determined using a predicted load for the plant and a standard deviation of the predicted load for the plant.
